(19) United States
(12) Patent Application Publication
(10) Pub. No.: US 2008/0239372 A1
(43) Pub. Date: Oct. 2, 2008

(54) IMAGE FORMING SYSTEM, SERVER APPARATUS, IMAGE FORMING APPARATUS, IMAGE FORMING APPARATUS CONTROL METHOD AND IMAGE FORMING APPARATUS CONTROL PROGRAM

(75) Inventors: Tomoyuki OKAMOTO, Osaka (JP); Kazuo MATOBA, Akashi-shi (JP); Tomo TSUBOI, Itami-shi (JP); Yoshinori SUGAHARA, Kyoto-shi (JP); Satoshi DEISHI, Osaka (JP); Kagumi MORIWAKI, Kawanishi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/035,749

(22) Filed: Feb. 22, 2008

(30) Foreign Application Priority Data
Mar. 30, 2007 (JP) 2007-094113

(51) Int. Cl. G06F 15/00

(52) U.S. Cl. 358/1.15

(57) ABSTRACT

An image forming apparatus and a server apparatus controlling the image forming apparatus are interconnected via a network. The image forming apparatus comprises: an executor that executes at least one from the image reading function, the copy function and the print function; an operation portion; and a communicator that exchanges information with the server apparatus. The server apparatus comprises: a communicator that exchanges information with the image forming apparatus; and a virtual image forming apparatus that is set up by software, as a controller portion dominantly controlling the entire image forming apparatus including the executor. In the virtual image forming apparatus on the server apparatus controls the image forming apparatus by commands, and thereby the image forming apparatus performs operations as if acting on a voluntary basis, in response to an instruction given by a user via an operation portion of the image forming apparatus itself.

This application claims priority under 35 U.S.C. § 119 to Japanese Patent Application No. 2007-94113 filed on Mar. 30, 2007, the entire disclosure of which is incorporated herein by reference in its entirety.

### BACKGROUND OF THE INVENTION

1. Field of the Invention

The present invention relates to an image forming system in which an image forming apparatus having at least one from an image reading function, a copy function and a print function and a server apparatus controlling the image forming apparatus are interconnected via a network, a server apparatus and an image forming apparatus preferably used in this image forming system, an image forming apparatus control method, and an image forming apparatus control program stored in a computer readable recording medium to execute processing.

2. Description of the Related Art

The following description sets forth the inventor's knowledge of related art and problems therein and should not be construed as an admission of knowledge in the prior art.

For recent years, it has become commonly seen that a plurality of image forming apparatuses that are copiers, printers and MFP (Multi Function Peripherals) that are multifunctional digital machines, are connected to a network and used in offices and other circumstances.

However, if there are more image forming apparatuses set up therein, it would be more troublesome and complicated to maintain and administer the respective image forming apparatuses, since they store hardware and software therein to execute their various functions.

It is disclosed in Japanese Unexamined Laid-open Patent Publication No. 2001-344162, that a plurality of personal computers, a full-color scanner, a monochrome scanner, a full-color printer, a monochrome printer, a FAX server, a FAX apparatus and a multifunction control apparatus are interconnected via a network, and the multifunction control apparatus: displays apparatuses to set up a virtual multifunctional machine on a network; picks up some of the apparatuses to make them work together; controls their operations; and exchanges data between the apparatuses.

With this art disclosed in the publication above, some image forming apparatuses are picked up to be made work together as a multifunctional machine. However, this art is not to resolve the issue mentioned above, i.e. it would be still troublesome and complicated to maintain and administer the respective image forming apparatuses.

Further, with this art, a user uses a terminal apparatus that is a personal computer to give instructions to a virtual multifunctional machine. Therefore, he/she has to give up the same user operability experienced with his/her usually using image forming apparatus, which is inconvenient.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an objective of the present invention to provide an image forming system that is capable of making it easier and simpler to maintain and administer the increasing number of image forming apparatuses, without losing the user operability experienced with a usually using image forming apparatus.

It is another objective of the present invention to provide a server apparatus preferably used in the image forming system.

It is yet another objective of the present invention to provide an image forming apparatus preferably used in the image forming system.

It is still yet another objective of the present invention to provide a control method to control the image forming apparatus.

It is still yet another objective of the present invention to provide a control program stored in a computer readable recording medium, to control the image forming apparatus.

According to a first aspect of the present invention, an image forming system in which an image forming apparatus having at least one from the image reading function, the copy function and the print function, and a server apparatus controlling the image forming apparatus, are interconnected via a network, and
the image forming apparatus comprising:
   an executor that executes at least one from the image reading function, the copy function and print function;
   an operation portion that enters an instruction given by a user to execute the functions; and
   a communicator that exchanges information with the server apparatus, and
the server apparatus comprising:
   a communicator that exchanges information with the image forming apparatus; and
   a virtual image forming apparatus that is set up by software, as a controller portion dominantly controlling the entire image forming apparatus including the executor, and
      wherein the virtual image forming apparatus on the server apparatus controls the image forming apparatus by commands, and thereby the image forming apparatus performs operations as if acting on a voluntary basis, in response to an instruction given by a user via the operation portion of the image forming apparatus itself.

According to a second aspect of the present invention, a server apparatus comprises:
a communicator that exchanges information via a network, with an image forming apparatus having at least one from the image reading function, the copy function and the print function; and
a virtual image forming apparatus that is set up by software, as a controller portion dominantly controlling the entire image forming apparatus including its executor that executes at least one from the image reading function, the copy function and the print function of the image forming apparatus, and
   wherein the virtual image forming apparatus controls the image forming apparatus by commands, and thereby the image forming apparatus performs operations as if acting on a voluntary basis, in response to an instruction given by a user via an operation portion of the image forming apparatus itself.

According to a third aspect of the present invention, an image forming apparatus comprises:
an executor that executes at least one from the image reading function, the copy function and the print function;
an operation portion that enters an instruction given by a user to execute the functions;
a communicator that exchanges information with a server apparatus via a network,
   which is dominantly controlled by a virtual image forming apparatus that is set up as a controller portion by software on the server apparatus, and thereby performs operations as if acting on a voluntary basis, in response to an instruction given by a user via the operation portion of the image forming apparatus itself.

According to a fourth aspect of the present invention, an image forming apparatus control method comprises:
exchanging information via a network, with an image forming apparatus having at least one from the image reading function, the copy function and the print function; and
activating a virtual image forming apparatus set up as a controller portion by software on a server apparatus, to control dominantly the entire image forming apparatus including its executor that executes at least one from the image reading function, the copy function and the print function of the image forming apparatus, and thereby making the image forming apparatus perform operations as if acting on a voluntary basis, in response to an instruction given by a user via an operation portion of the image forming apparatus.

According to a fifth aspect of the present invention, an image forming apparatus control program stored in a computer readable recording medium to make a computer execute:
exchanging information via a network, with an image forming apparatus having at least one from the image reading function, the copy function and the print function; and
activating a virtual image forming apparatus set up as a controller portion by software on a server apparatus, to control dominantly the entire image forming apparatus including its executor that executes at least one from the image reading function, the copy function and the print function of the image forming apparatus, and thereby making the image forming apparatus perform operations as if acting on a voluntary basis, in response to an instruction given by a user via an operation portion of the image forming apparatus.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view showing a configuration of an image forming system according to one embodiment of the present invention;

FIG. 2 is a block diagram schematically showing a configuration of a server apparatus used in the system shown in FIG. 1;

FIG. 3 is a block diagram schematically showing a configuration of an image forming apparatus used in the system shown in FIG. 1;

FIG. 4 is a view to explain how the image forming apparatus works as a thin client of a virtual multifunctional machine that is set up on the server apparatus;

FIG. 5 is a view to explain a configuration of the image forming system in which any of a plurality of virtual multifunctional machines set up on the server apparatus can control the image forming apparatus;

FIG. 6 is view to explain a configuration of the image forming system having image forming apparatuses with different specifications for respective users;

FIG. 7 is a view showing a user authentication information table;

FIG. 8 is a view showing an example of an authentication reception screen displayed on the image forming apparatus;

FIG. 9 is a view showing an example of a function selection screen to select functions for a machine model A;

FIG. 10 is a view showing an example of a function selection screen to select functions for a machine model C;

FIG. 11 is a flowchart showing a procedure executed in the image forming apparatus and the server apparatus, if a user gives an instruction via an operation panel;

FIG. 12 is a view showing a configuration of an image forming system according to another embodiment of the present invention, and wherein a virtual multifunctional machine is set up to make a plurality of image forming apparatuses work together as one image forming apparatus;

FIG. 13 is a view showing an example of a main function setting screen;

FIG. 14 is a view showing an example of an additional function setting screen;

FIG. 15 is a view showing an example of a setup completion screen displayed after successfully setting up the virtual multifunctional machine; and

FIG. 16 is a flowchart showing a procedure to set up the virtual multifunctional machine to make the plurality of image forming apparatuses work together as one image forming apparatus.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

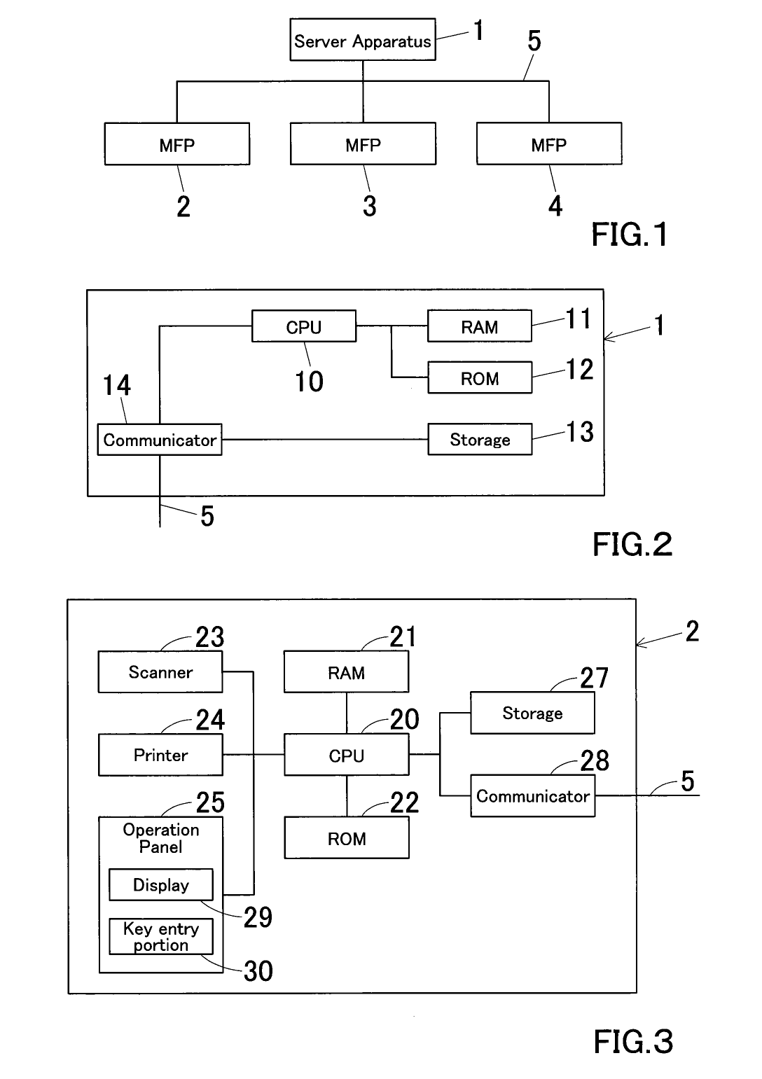

FIG. 1 is a view showing an entire configuration of an image forming system according to one embodiment of the present invention.

The image forming system comprises a server apparatus 1 and image forming apparatuses 2, 3 and 4 interconnected via a network 5.

FIG. 2 is a block diagram showing a configuration of the server apparatus 1.

The server apparatus 1 is a personal computer, and comprises a CPU 10, a RAM 11, a ROM 12, a storage 13, a communicator 14 and etc.

The CPU 10 centrally controls the overall server apparatus 1, and also dominantly controls all the operations of the image forming apparatuses 2, 3 and 4. Further, the CPU 10 centrally administers various information shared within the entire image forming system. What the CPU 10 controls will be described later in details.

The RAM 11 is used by the CPU 10 as an operation area to execute a program. Further, the RAM 11 temporarily stores in itself a program, data to execute the program and other data.

The ROM 12 stores in itself a program executed by the CPU 10, and other data.

The storage 13 is a nonvolatile recording medium such as a hard disk drive, and stores in itself image data read out in the image forming apparatuses 2, 3 and 4, user authentication information used for user authentication etc., and other data. Further, in this embodiment, the storage 13 also stores in itself a program and data to activate a virtual multifunctional machine that is a virtual image forming apparatus. The virtual multifunctional machine will be detailed later.

The communicator 14 exchanges image data, user information and other data with the image forming apparatuses 2, 3 and 4 via the network 5. The communicator 14 is a NIC (Network Interface Card) or other.

FIG. 3 is a block diagram schematically showing a configuration of the image forming apparatus 2. Explanation about configurations of the image forming apparatuses 3 and 4 is omitted here, since those are exactly the same as that of the image forming apparatus 2.

In this embodiment, a MFP (Multi Function Peripheral) that is a digital multifunctional machine is employed as the image forming apparatus 2. It should be noted that “image forming apparatus” will be also referred to as “multifunctional machine” hereinafter.

The multifunctional machine 2 comprises a CPU 20, a RAM 21, a ROM 22, a scanner 23, a printer 24, an operation panel 25, a storage 27, a communicator 28 and etc.

When a job is executed, the CPU 20 controls the respective portions of the multifunctional machine 2 according to commands received from the CPU 10 of the server apparatus 1.

The RAM 21 is used by the CPU 20 as an operation area to execute a program. Further, the RAM 21 temporarily stores in itself a program, data to execute the program, and other data.

The ROM 22 stores in itself a program executed by the CPU 20, and other data. Further, in this embodiment, the ROM 22 also stores in itself a program and data to make the CPU 20 of the multifunctional machine 2 perform operations according to commands received from the CPU 10 of the server apparatus 1.

The scanner 23 reads a document placed on its automatic document feeder or platen glass by a user at a predetermined resolution according to commands received from the CPU 10 of the server apparatus 1, then converts it into electronic data. The scanner 23 comprises a light source, a prism, a CCD and etc.

The printer 24 prints on a sheet image data read out from a document and other image data according to commands received from the CPU 10 of the server apparatus 1. The printer 24 has a structure suitable for various print methods such as electrograph, inkjet and thermal transfer.

The operation panel 25 is used to display on itself various messages for users, an entry reception screen, a selection screen and etc., or is used by a user to enter an instruction to use the multifunctional machine 2. The operation panel 25 comprises a touch panel display 29 such as a liquid crystal display, and a key entry portion 30 such as a numeric key pad.

The storage 27 is a nonvolatile recording medium such as a hard disk drive, and stores in itself image data read out from a document by the scanner 23, software and etc.

The communicator 28 exchanges image data and other data with the server apparatus 1, the multifunctional machines 3 and 4, via the network 5. The communicator 28 is a NIC (Network Interface Card) or other.

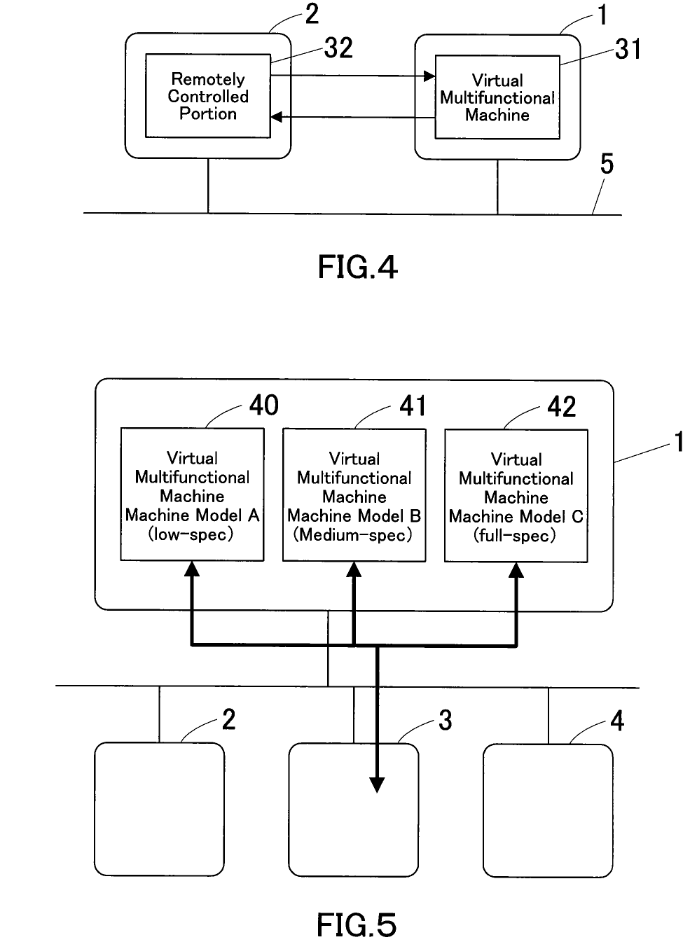

In this embodiment, the respective multifunctional machines 2, 3 and 4 work as thin clients of a virtual multifunctional machine set up on the server apparatus 1, which will be hereinafter explained with reference to FIG. 4.

As shown in FIG. 4, the server apparatus 1 has a virtual multifunctional machine 31. The virtual multifunctional machine 31 is virtually set up by software (by a program) to dominantly control the respective multifunctional machines 2, 3 and 4, i.e. the virtual multifunctional machine 31 works as a controller portion controlling the respective multifunctional machines 2, 3 and 4. The virtual multifunctional machine 31 controls the entire operations performed in the respective multifunctional machine 2, 3 and 4 by transmitting control commands thereto and exchanging data therewith.

On the other hand, each of the multifunctional machines 2, 3 and 4 has a remotely controlled portion 32. The remotely controlled portion 32 is a program executed in each of the multifunctional machines 2, 3 and 4. If the remotely controlled portion 32 is executed, the thin client function is activated, and thereby a predetermined procedure is executed according to control commands received from the virtual multifunctional machine 31 activated on the server apparatus 1.

With this configuration described above, the respective multifunctional machines 2, 3 and 4 can delegate their entire control tasks to the virtual multifunctional machine 31 activated on the server apparatus 1. In other words, since the respective multifunctional machines 2, 3 and 4 have the thin client function, the server apparatus 1 can take over their entire control tasks. Concretely, the respective multifunctional machines 2, 3 and 4 perform operations as if acting on a voluntary basis, meanwhile they are actually controlled by commands received from the virtual multifunctional machine 31 activated on the server apparatus 1. It is an advantage of using the thin client function that the multifunctional machines do not need to have complicated software and etc. installed thereon to execute the image reading function, the print function and other functions, and even if there are the more number of multifunctional machines set up on the network, it would be not such troublesome or complicated to maintain and administer the respective multifunctional machines, under the condition that the server apparatus has the actual control function to control the respective multifunctional machines.

FIG. 5 is a view to explain a configuration of an image forming system in which virtual multifunctional machines 40, 41 and 42 are activated on the server apparatus 1 and any of the virtual multifunctional machines 40, 41 and 42 can control the respective multifunctional machines 2, 3 and 4.

The respective virtual multifunctional machines 40, 41 and 42 have different programs to make the multifunctional machines perform operations as different machine models (machines with different specifications).

The virtual multifunctional machine 40 performs operations as a machine model A having the least number of available functions among the three virtual multifunctional machines. The virtual multifunctional machine 42 performs operations as a machine model C having the greatest number of available functions among the three multifunctional machines, which is full-spec. The virtual multifunctional machine 41 performs operations as a machine model B having some number of available functions, which is intermediate between the machine model A and the machine model C.

The respective multifunctional machines 2, 3 and 4 can be controlled by any of the virtual multifunctional machines 40, 41 and 42. Therefore, even if the multifunctional machines 2, 3 and 4 are capable of executing the same functions, their specifications (models) can be differentiated depending on which among the virtual multifunctional machines 40, 41 and 42 activated on the server apparatus 1 controls them. In this embodiment, which among the virtual multifunctional machines 40, 41 and 42 should control which among the multifunctional machines 2, 3 and 4, can be configured in advance, or can be arbitrarily configured by users via the operation panels 25 of the multifunctional machines 2, 3 and 4.

Further, the server apparatus 1 can change a specification of one multifunctional machine by switching the controller machine controlling this multifunctional machine, to the virtual multifunctional machines 40, 41 or 42. Therefore, one multifunctional machine can be used as those with different specifications depending on usages. For example, one multifunctional machine can be used as a full-spec multifunctional machine just for a certain trial period, by a user who is ordinarily authorized to use only a multifunctional machine with the minimum specification.

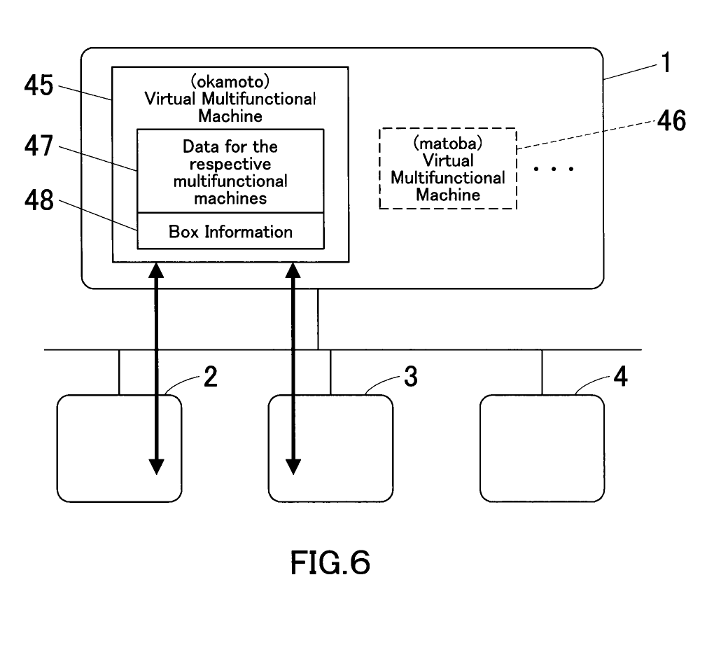

FIG. 6 is a view to explain a configuration of an image forming system in which multifunctional machines with different specifications are configured for respective users.

In this embodiment, virtual multifunctional machines are assigned to respective users. As shown in FIG. 6, a virtual multifunctional machine 45 assigned to a user with the account ID “okamoto” and a virtual multifunctional machine 46 assigned to a user with the account ID “matoba” are set up on the server apparatus 1. With this configuration including the virtual multifunctional machines 45 and 46, he/she can always use any of the multifunctional machines 2, 3 and 4 with the same configuration. For example, when a user with the account ID “okamoto” intends to use any of the multifunctional machines, the virtual multifunctional machine 45 preliminarily assigned to this user is always activated on the server apparatus 1, and thereby this user's using multifunctional machine is controlled by the virtual multifunctional machine 45. Therefore, a user can always use any of the multifunctional machines, with the same specification and with the same user operability.

Further, data 47 for the respective multifunctional machines and BOX information 48 that is information of storage areas assigned to respective users are stored in the storage 13 of the server apparatus 1, with relationship to the virtual multifunctional machines 45 and 46. With this configuration, image data read out in the multifunctional machines 2, 3 and 4 and other data can be stored in the server apparatus 1, with relationship to the virtual multifunctional machines 45 and 46 assigned for respective users. Therefore, for example, image data read out from a document in the multifunctional machine 2 can be printed out from the multifunctional machine 3.

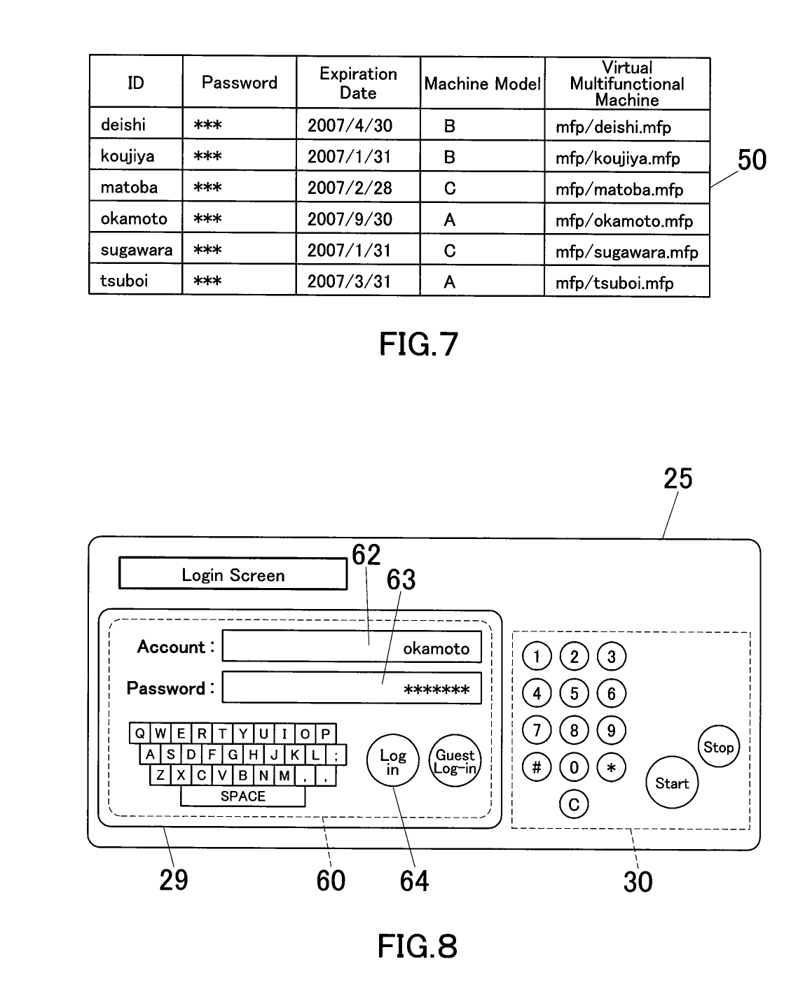

As described above, to activate on the server apparatus 1 itself the virtual multifunctional machine 45 or 46 preliminarily assigned for a user using the multifunctional machine 2, 3 or 4, the server apparatus 1 needs to identify this user by performing user authentication then identify a virtual multifunctional machine preliminarily assigned to this user. For this purpose, user authentication information referred to a user authentication information table 50 of FIG. 7 is stored in the storage 13 of the server apparatus 1.

The user authentication information includes information of “ID”, “password”, “expiration date”, “machine model” and “virtual multifunctional machine”. The “ID” indicates an account ID uniquely assigned to one user. The “password” indicates a letter string of password used for user authentication, but it also can indicate biometric information used for user authentication that is performed in cooperation with a biometric device, for example. The “expiration date” indicates a date on which an account is expired, and user authentication by using an expired account basically fails. The “machine model” indicates a model of virtual multifunctional machine, in other words, a specification of a virtual multifunctional machine assigned to a user. The “virtual multifunctional machine” indicates a name of an image file (program) executing a virtual multifunctional machine, and indicates a location (directory path) of the image file containing the entire information to control the multifunctional machines.

And the user “ID” is related to the respective information of “password”, “expiration date”, “machine model” and “virtual multifunctional machine”.

To administer user authentication information, the server apparatus 1 can be configured to store such a table explained above, and also can be configured to store programs executing the virtual multifunctional machines activated for the respective users, in user administration areas of an operation system (OS) that is run on the server apparatus 1 itself.

Hereinafter, user operations to use a multifunctional machine will be explained.

FIG. 8 shows an authentication reception screen 60 displayed on the display 29 of the operation panel 25 of the multifunctional machines 2, 3 and 4.

In this authentication reception screen 60, an account ID entry field 62, a password entry field 63, a login button 64 and etc. are displayed.

When a user enters an account ID and a password in the account ID entry filed 62 and the password entry field 63, respectively, by using keys or other of the key entry portion 30 of the multifunctional machine 2 for example, then presses the login button 64, the entered information is transmitted to the server apparatus 1 via the communicator 28.

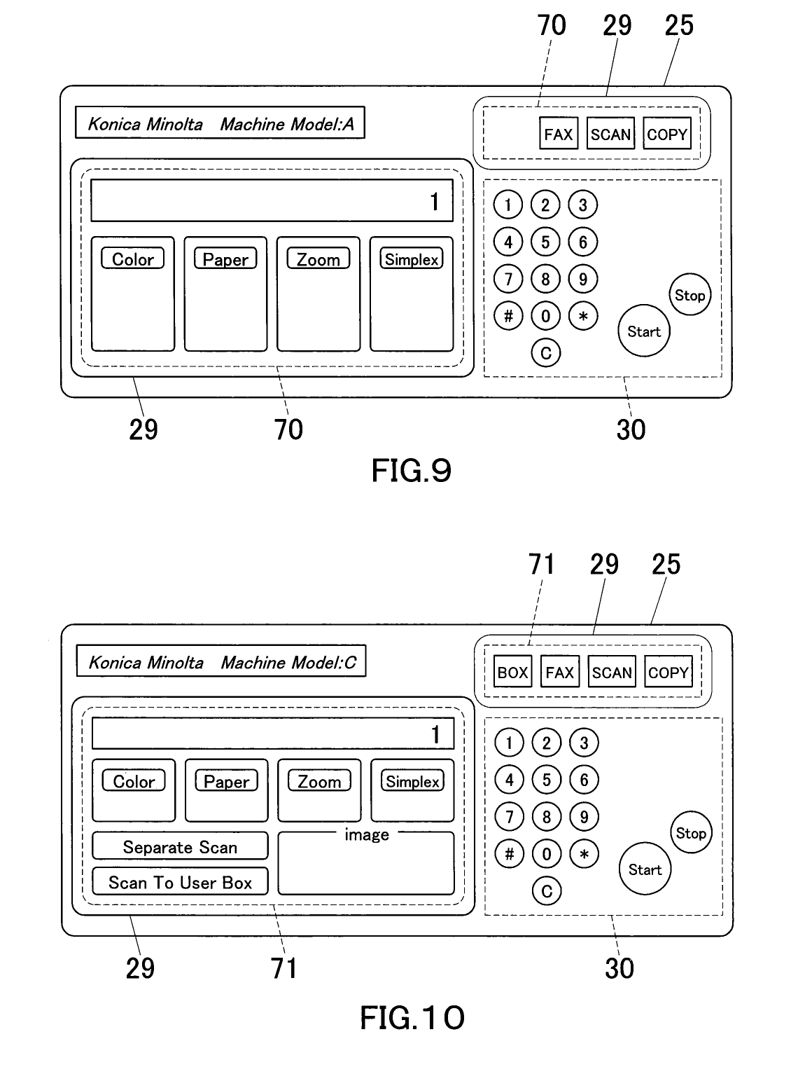

For example, “okamoto” is entered in the account ID entry field 62, an appropriate password is entered in the password entry field 63, and the login button 64 is pressed. And then, the entered information is transmitted and user authentication is performed in the server apparatus 1. If user authentication succeeds, a function selection screen 70 for the machine model A is displayed on the display 29 of the operation panel 25 as shown in FIG. 9, since the account ID “okamoto” is registered in the user authentication information table 50 with relationship to the model A of virtual multifunctional machine.

In an alternative manner, “matoba” is entered in the account ID entry field 62, and an appropriate password is entered in the password entry field 63, and the login button 64 is pressed. And then, user authentication is performed in the server apparatus 1. If user authentication succeeds, a function selection screen 71 for the machine model C is displayed on the display 29 as shown in FIG. 10, since the account ID “matoba” is registered in the user authentication information table 50 with relationship to the model C of virtual multifunctional machine.

The model C of virtual multifunctional machine is full-spec and higher functional than the model A of virtual multifunctional machine. Comparing the function selection screen 70 of FIG. 9 and the function selection screen 71 of FIG. 10, there are optional functions: “FAX”, “SCAN” and “COPY” in the function selection screen 70 of FIG. 9, meanwhile, “FAX”, “SCAN”, “COPY” and BOX” in the function selection screen 71 of FIG. 10.

In this way as described above, available functions of the multifunctional machines can be limited depending on users. Further, the server apparatus 1 can be configured to start accounting if a certain optional function is enabled.

Further, in these embodiments shown in FIG. 8 though FIG. 10, the virtual multifunctional machine 45 or 46 assigned to a user logging on the multifunctional machines 2, 3 or 4 is activated, then a function selection screen having optional functions that meets a specification of the setup virtual multifunctional machine, is displayed on the multifunctional machine of this logon user. However, it also can be configured such that a virtual multifunctional machine preliminarily assigned to the multifunctional machine 2, 3 or 4 of a logon user is activated, or a virtual multifunctional machine with a preferable specification (machine model) selected by a logon user is activated, as previously mentioned. And then, a function selection screen for the setup virtual multifunctional machine is displayed.

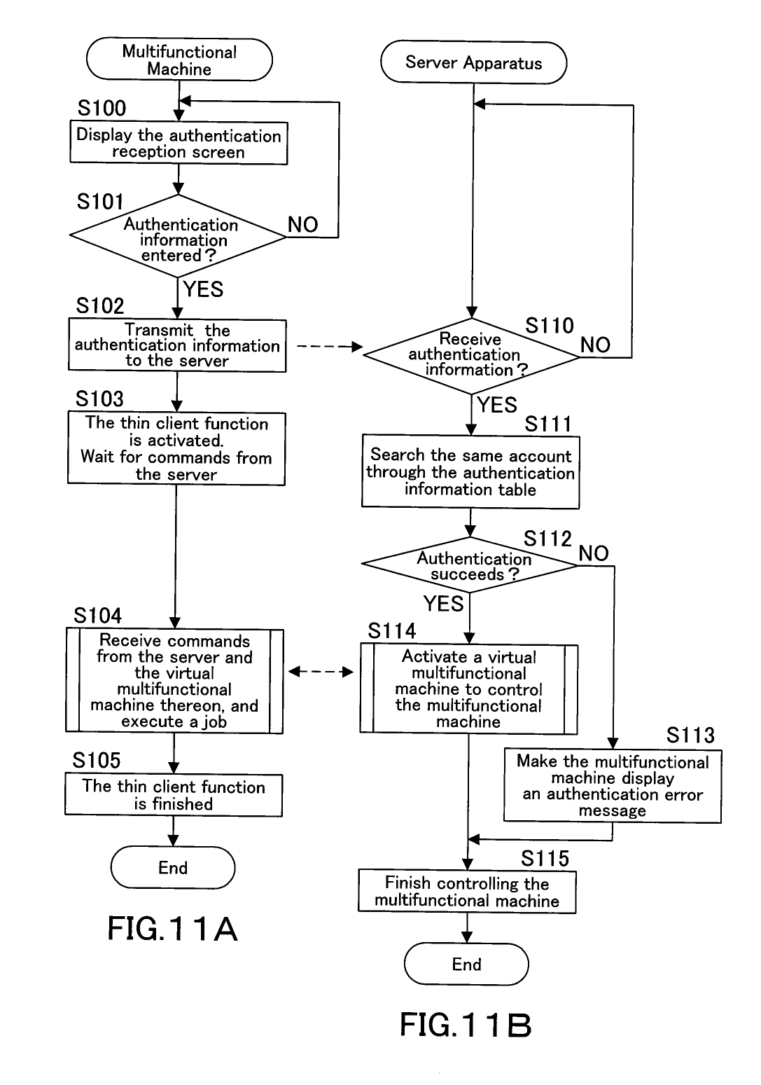

Subsequently, a procedure executed in the multifunctional machines 2, 3 and 4, and the server apparatus 1 if a user gives an instruction via the operation panel 25, will be explained with a flowchart shown in FIG. 11. In this embodiment, a user logs on the multifunctional machine 2 for example. The procedure is executed by the CPU 20 of the multifunctional machine 2 and the CPU 10 of the server apparatus 1, according to a program.

According to FIG. 11(A) showing a procedure executed in the multifunctional machine 2, the authentication reception screen 60 is displayed on the display 29 (Step S100), and it is judged whether or not an account ID and a password are entered by a user (Step S101).

If authentication information is not entered (NO in Step S101), the routine waits until it is entered. If authentication information is entered (YES in Step S101), the entered authentication information is transmitted to the server apparatus 1 via the communicator 28 (Step S102). Then the thin client function is activated so that the multifunctional machine could be controlled by a virtual multifunctional machine, and the routine waits until commands are received from the server apparatus 1 (Step S103).

If commands are received from the server apparatus 1, a job given by the user is executed based on data exchanged with the server apparatus 1 and according to commands received from the server apparatus 1 (Step S104). When job execution is completed, the thin client function is finished (Step S105).

Meanwhile, according to FIG. 11(B) showing a procedure executed in the server apparatus 1, it is judged whether or not authentication information is received from the multifunctional machine 2 (Step S110). If authentication information is not yet received (NO in Step S110), the routine waits until it is received. If authentication information is received (YES in Step S110), an account ID that is the same as that included in the received authentication information is searched through the user authentication information table 50 (Step S111), and it is judged whether or not there exists the same account ID therein, in other words, authentication succeeds (Step S112).

If authentication fails (NO in Step S112), an authentication error message is transmitted to the multifunctional machine 2 via the communicator 14 and displayed on the operation panel 25 of the multifunctional machine 2 (Step S113). Then the routine to control the multifunctional machine 2 terminates (Step S115).

If authentication succeeds (YES in Step S112), the virtual multifunctional machine 45 or 46 preliminarily assigned to a user is activated, and makes the multifunctional machine 2 execute a job given by this user (Step S114). Then the routine to control the multifunctional machine 2 terminates (Step S115).

As described above in this embodiment, virtual multifunctional machines are activated for respective authorized users, which would ensure higher security. Further, respective users can use multifunctional machines with their appropriate specifications, which would improve user convenience of the image forming system.

In this embodiment explained with in FIG. 11, a virtual multifunctional machine preliminarily assigned to a logon user is activated. However, it can be configured such that a virtual multifunctional machine preliminarily assigned to the multifunctional machine 2 of a logon user is activated. In this case, the virtual multifunctional machine 45 or 46 preliminarily assigned to the multifunctional machine 2 is searched in Step S111 of FIG. 11(B), and it is judged in Step S112 whether or not it is searched out.

Hereinafter, another embodiment of the present invention will be explained.

In this embodiment, if a plurality of multifunctional machines are connected to the network 5, a virtual multifunctional machine is set up to make the plurality of multifunctional machines work together as one multifunctional machine, and the virtual multifunctional machine enables the respective plurality of multifunctional machines to execute different functions.

Since configurations of the server apparatus 1, the multifunctional machines 2, 3 and 4 according to this embodiment are exactly the same as those explained in the other embodiment of FIG. 1 through FIG. 11, their explanations are omitted.

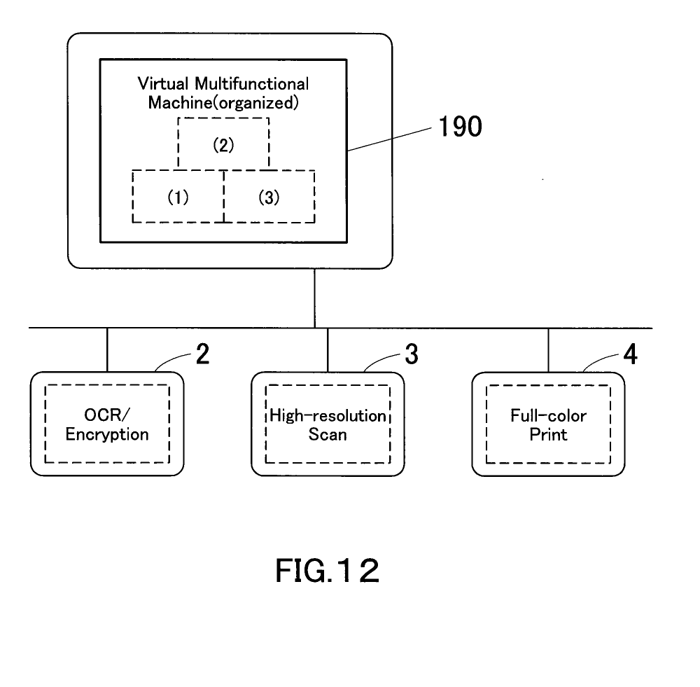

FIG. 12 is a view showing a virtual multifunctional machine 190 that is set up on the server apparatus 1 to make the multifunctional machines 2, 3 and 4 work together as one multifunctional machine.

The virtual multifunctional machine 190 enables the multifunctional machine 2 to execute the character recognition function and the encryption function, the multifunctional machine 3 to execute the high-resolution scan function, and the multifunctional machine 4 to execute the full-color print function.

Hereinafter, operations to set up the virtual multifunctional machine 190 to make the plurality of multifunctional machines 2, 3 and 4 work together, will be explained.

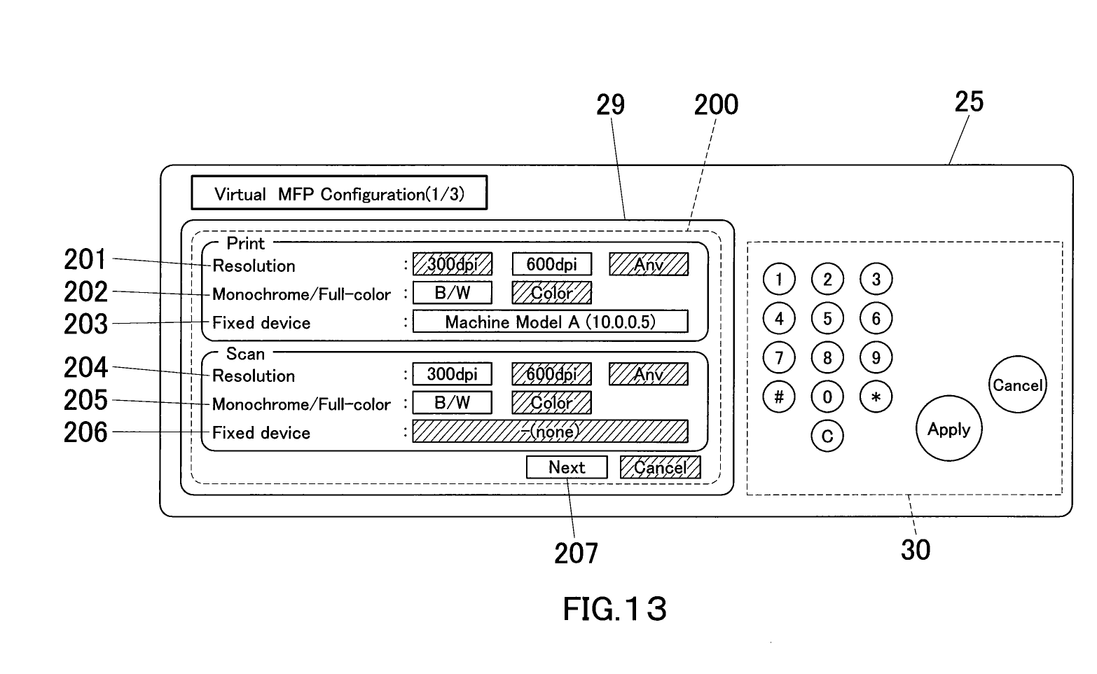

For example, a user sets conditions of his/her preferable function via a main function setting screen 200 that is displayed on the operation panel 25 of the multifunctional machine 2. As shown in FIG. 13, a print resolution selection field 201, a monochrome/full-color print selection field 202, a fixed print device field 203, a scan resolution selection field 204, a monochrome/full-color scan selection field 205, a fixed scan device field 206 and etc. are displayed in the main function setting screen 200, and a user enters conditions in the respective selection fields. Via this screen, a user can specify his/her preferable multifunctional machine by filling in the fixed print device field 203 and the fixed scan device field 206. For example, if a user specifies as a printer a multifunctional machine located in his/her most vicinity as shown in FIG. 13, he/she can always it to execute a print job.

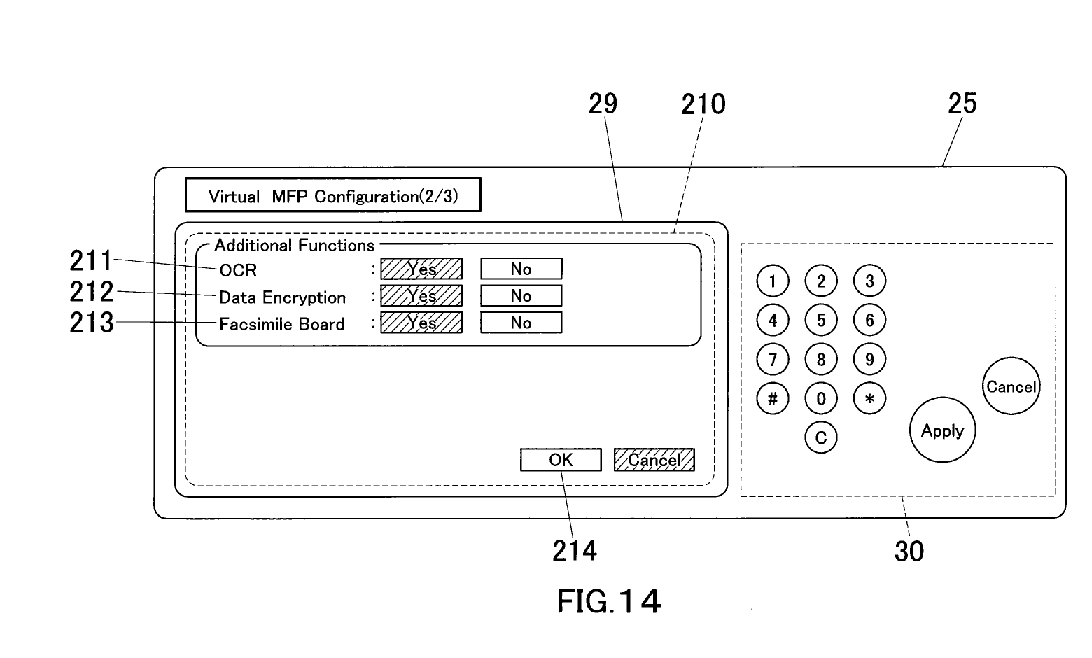

If a “NEXT” button 207 is pressed after conditions are entered in the respective selection fields, the screen is switched to an additional function setting screen 210 shown in FIG. 14.

In the additional function setting screen 210, an OCR function selection field 211, a data encryption selection field 212, a facsimile board selection field 213 and etc. are displayed, and the user selects whether or not to execute the respective functions.

If an “OK” button 214 is pressed after user selection, the information selected by the user is transmitted to the server apparatus 1, as configuration information.

Then, in the server apparatus 1, appropriate or the most appropriate multifunctional machines to execute the respective functions are picked up and arranged to work together, and thereby the virtual multifunctional machine 190 is successfully set up to control these multifunctional machines. If the user preliminarily specifies multifunctional machines to execute the respective functions, the specified multifunctional machines are picked up. In this way, the virtual multifunctional machine 190 is successfully activated to control the multifunctional machines, and thereby the multifunctional machine 2 is enabled to perform character recognition and encryption, the multifunctional machine 3 is enabled to perform high-resolution scan, and the multifunctional machine 4 is enabled to perform full-color print, as mentioned above.

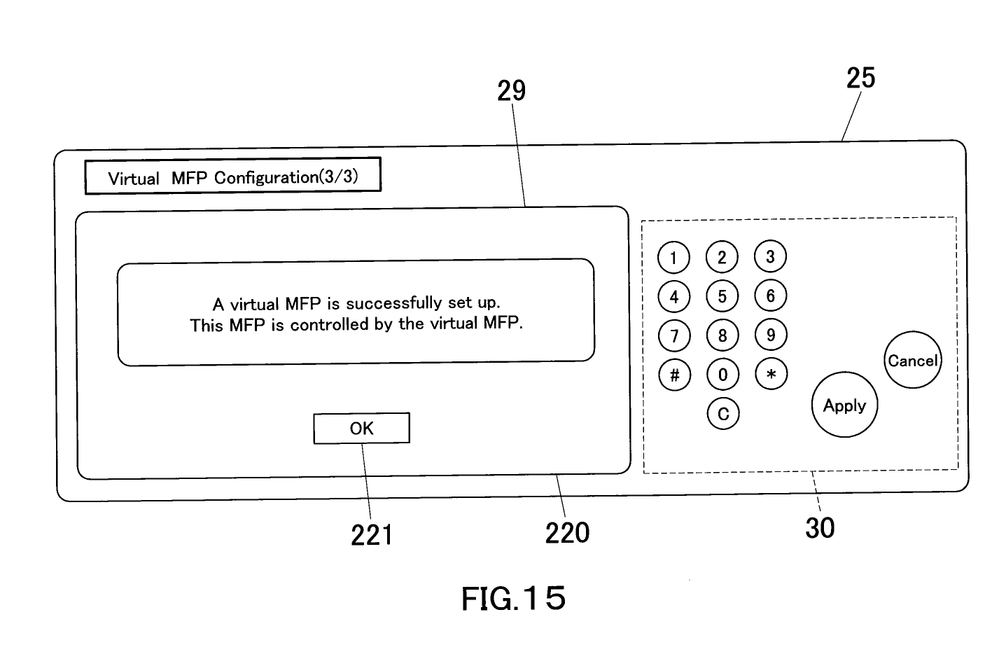

After the virtual multifunctional machine 190 is set up, the server apparatus 1 transmits a notice of setup success. When the multifunctional machine 2 receives the notice from the server apparatus 1, a setup completion screen 220 shown in FIG. 15 is displayed on the display 29. In this setup completion screen 220, a message is displayed to let the user know that a virtual multifunctional machine is successfully set up to control the multifunctional machine 2, and an “OK” button 221 is also displayed. If the user presses the “OK” button 221, the screen is switched to a job reception screen (not shown in Figure) and stays as is, until a job is given by the user. If the user enters a job via the screen, then the job is executed by the multifunctional machines 2, 3 and 4 under the control of the virtual multifunctional machine 190.

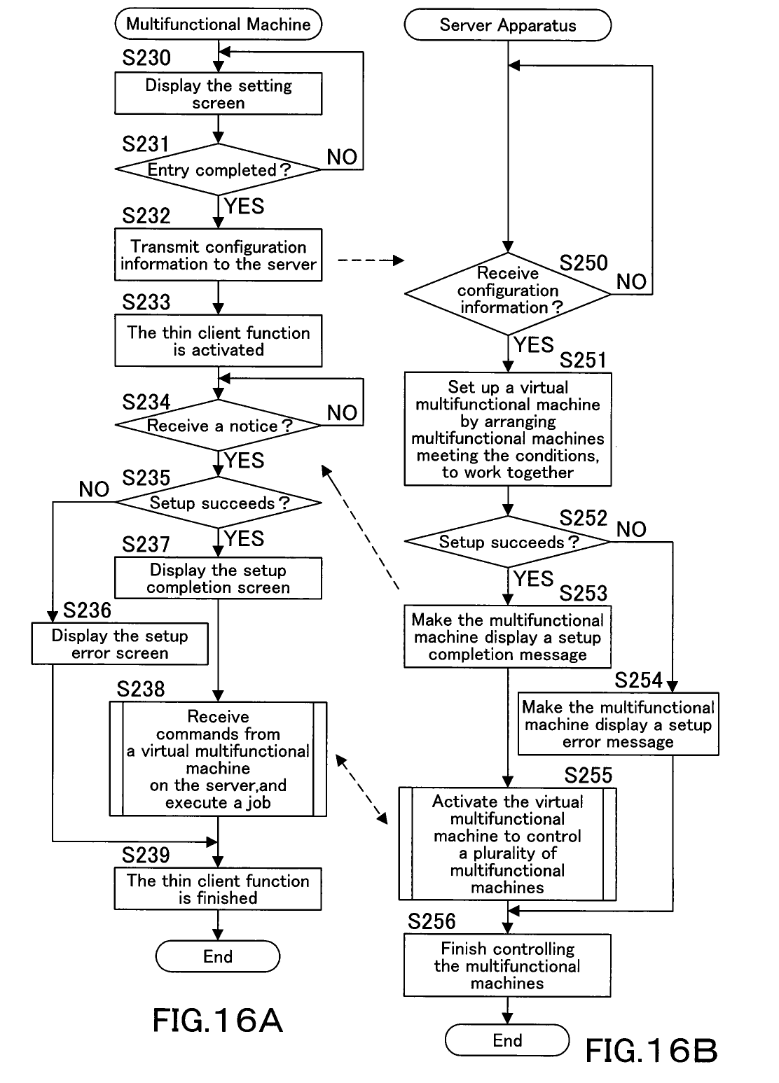

Hereinafter, a procedure performed in the multifunctional machines and the server apparatus 1 to set up a virtual multifunctional machine based on configuration information that is entered by the user via the operation panel 25, will be explained with a flowchart shown in FIG. 16. This procedure is executed by the CPU 20 of the multifunctional machine 2 and the CPU 10 of the server apparatus 1, according to a program.

According to FIG. 16(A) showing a procedure executed in the multifunctional machine 2, the main function setting screen 200 is displayed on the display 29, subsequently the additional function setting screen 210 is displayed thereon (Step S230). Then it is judged whether or not setting conditions are completely entered by a user (Step S231).

If setting conditions are not yet completely entered (NO in Step S231), the routine waits until those are completely entered. If setting conditions are completely entered by a user (YES in Step S231), the entered configuration information is transmitted to the server apparatus 1 via the communicator 28 (Step S232), then the thin client function is activated so that the multifunctional machine 2 could be controlled by a virtual multifunctional machine (Step S233).

Subsequently, it is judged whether or not a notice regarding setup of a virtual multifunctional machine is received from the server apparatus 1 (Step S234). If such a notice is not yet received (NO in Step S234), the routine waits until it is received. If such a notice is received (YES in Step S234), what the notice indicates is judged as setup success or setup error (Step S235). If it is setup error (NO in Step S235), a setup error screen is displayed on the display 29 to let the user know setup error (Step S236). Then the thin client function is finished (Step S239).

If what the notice indicates is setup success (YES in Step S235), the setup completion screen 220 is displayed on the display 29 to let the user know setup success (Step S237). If the user gives an instruction to execute a job after pressing the “OK” button 221, the job is executed based on data exchanged with the server apparatus 1 and according to commands received from the server apparatus 1 (Step S238). When job execution is completed, the thin client function is finished (Step S239).

Meanwhile, according to FIG. 16(B) showing a procedure executed in the server apparatus 1, it is judged whether or not configuration information is received from the multifunctional machine 2 (Step S250). If it is not yet received (NO in Step S250), the routine waits until it is received. If it is received (YES in Step S250), appropriate multifunctional machines to execute the requested functions are searched out based on the received configuration information and arranged to work together, and thereby the virtual multifunctional machine 190 is successfully set up (Step S251). Then it is judged whether or not setup succeeds (Step S252).

If setup fails (NO in Step S252), under the control of the server apparatus, a setup error message is displayed on the display 29 of the multifunctional machine 2 (Step S254), then the control operation is terminated (Step S256). If setup succeeds (YES in Step S252), under the control of the server apparatus, a setup completion message is displayed on the display 29 of the multifunctional machine 2 (Step S253), then the setup virtual multifunctional machine 190 is activated. Then, under the control, a job given by a user is executed by the multifunctional machines 2, 3 and 4 working together (Step S255). When job execution is completed, the operations to control the multifunctional machines are finished (Step S256).

As described above in this embodiment, a virtual multifunctional machine is set up to make a plurality of multifunctional machines work together, and thereby the virtual multifunctional machine controls the respective multifunctional machines. In other words, a plurality of multifunctional machines each having outstanding functions are arranged to work together as one multifunctional machine, which could accomplish higher user convenience of the image forming system.

Each of the embodiments explained above is one embodiment of the present invention, however, the present invention is not limited thereto.

For example, an image forming apparatus corresponds to a multifunctional machine in these embodiments. However, the image forming apparatus also can be a machine having more than one from the image reading function, the copy function and the print function, or having only one from them.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming system in which an image forming apparatus having at least one from the image reading function, the copy function and the print function, and a server apparatus controlling the image forming apparatus, are interconnected via a network, and
the image forming apparatus comprising:
an executor that executes at least one from the image reading function, the copy function and print function;
an operation portion that enters an instruction given by a user to execute the functions; and
a communicator that exchanges information with the server apparatus, and
the server apparatus comprising:
a communicator that exchanges information with the image forming apparatus; and
a virtual image forming apparatus that is set up by software, as a controller portion dominantly controlling the entire image forming apparatus including the executor, and
wherein the virtual image forming apparatus on the server apparatus controls the image forming apparatus by commands, and thereby the image forming apparatus performs operations as if acting on a voluntary basis, in response to an instruction given by a user via the operation portion of the image forming apparatus itself.

2. The image forming system recited in claim 1, wherein the server apparatus further comprises:
a plurality of virtual image forming apparatuses with different specifications for respective users; and
a searcher that searches a predetermined one among the plurality of virtual image forming apparatuses, and
the searcher searches a virtual image forming apparatus related to a user giving an instruction when it is given via the operation portion of the image forming apparatus, then the virtual image forming apparatus is activated, and thereby the activated virtual image forming apparatus controls the image forming apparatus.

3. The image forming system recited in claim 1, wherein there exist a plurality of image forming apparatuses, and the server apparatus further comprises:
a plurality of virtual image forming apparatuses with different specifications for the respective image forming apparatuses; and
a searcher that searches a predetermined one among the plurality of virtual image forming apparatuses, and
the searcher searches a virtual image forming apparatus related to any of the image forming apparatuses when an instruction is given via the operation portion of this image forming apparatus, then the virtual image forming apparatus is activated, and thereby the activated virtual image forming apparatus controls the image forming apparatus.

4. The image forming system recited in claim 1, wherein:
there exist a plurality of image forming apparatuses;
the server apparatus further comprises a setup portion that sets up a virtual image forming apparatus to control the image forming apparatuses and make them work together; and
the setup virtual image forming apparatus makes the respective image forming apparatuses execute different functions.

5. A server apparatus comprising:
a communicator that exchanges information via a network, with an image forming apparatus having at least one from the image reading function, the copy function and the print function; and
a virtual image forming apparatus that is set up by software, as a controller portion dominantly controlling the entire image forming apparatus including its executor that executes at least one from the image reading function, the copy function and
the print function of the image forming apparatus, and
wherein the virtual image forming apparatus controls the image forming apparatus by commands, and thereby the image forming apparatus performs operations as if acting on a voluntary basis, in response to an instruction given by a user via an operation portion of the image forming apparatus itself.

6. The server apparatus recited in claim 5, further comprising:
a plurality of virtual image forming apparatus with different specifications for respective users; and
a searcher that searches a predetermined one among the plurality of virtual image forming apparatuses, and
wherein the searcher searches a virtual image forming apparatus related to a user giving an instruction when it is given via the operation portion of the image forming apparatus, then the virtual image forming apparatus is activated, and thereby the activated virtual image forming apparatus controls the image forming apparatus.

7. The server apparatus recited in claim 5, further comprising:
a plurality of virtual image forming apparatuses with different specifications; and
a searcher that searches a predetermined one among the plurality of virtual image forming apparatuses, and
wherein the searcher searches a virtual image forming apparatus related to any of a plurality of image forming apparatuses when an instruction is given via the operation portion of this image forming apparatus, then the virtual image forming apparatus is activated, and thereby the activated virtual image forming apparatus controls the image forming apparatus.

8. The server apparatus recited in claim 5, further comprising a setup portion that sets up a virtual image forming apparatus to control a plurality of image forming apparatuses and make them work together, and wherein the setup virtual image forming apparatus makes the respective image forming apparatuses execute different functions.

9. An image forming apparatus comprising:
an executor that executes at least one from the image reading function, the copy function and the print function;
an operation portion that enters an instruction given by a user to execute the functions;
a communicator that exchanges information with a server apparatus via a network,
which is dominantly controlled by a virtual image forming apparatus that is set up as a controller portion by software on the server apparatus, and thereby performs operations as if acting on a voluntary basis, in response to an instruction given by a user via the operation portion of the image forming apparatus itself.

10. An image forming apparatus control method comprising:
exchanging information via a network, with an image forming apparatus having at least one from the image reading function, the copy function and the print function; and
activating a virtual image forming apparatus set up as a controller portion by software on a server apparatus, to control dominantly the entire image forming apparatus including its executor that executes at least one from the image reading function, the copy function and the print function of the image forming apparatus, and thereby making the image forming apparatus perform operations as if acting on a voluntary basis, in response to an instruction given by a user via an operation portion of the image forming apparatus.

11. The image forming apparatus control method recited in claim 10, further comprising:
searching among a plurality of virtual image forming apparatuses with different specifications for respective users, a virtual image forming apparatus related to a user giving an instruction when it is given via the operation portion of the image forming apparatus, then activating the virtual image forming apparatus, and
wherein:
the activated virtual image forming apparatus controls the image forming apparatus in the controlling step.

12. The image forming apparatus control method recited in claim 10, further comprising:
searching among a plurality of virtual image forming apparatuses with different specifications, a virtual image forming apparatus related to any of a plurality of image forming apparatuses when an instruction is given via the operation portion of this image forming apparatus, then activating the virtual image forming apparatus, and
wherein:
the activated virtual image forming apparatus controls the image forming apparatus in the controlling step.

13. The image forming apparatus control method recited in claim 10, further comprising:
setting up a virtual image forming apparatus to control a plurality of image forming apparatuses and make them work together;
making the respective image forming apparatuses execute different functions, by using the setup virtual image forming apparatus.

14. An image forming apparatus control program stored in a computer readable recording medium to execute:
exchanging information via a network, with an image forming apparatus having at least one from the image reading function, the copy function and the print function; and
activating a virtual image forming apparatus set up as a controller portion by software on a server apparatus, to control dominantly the entire image forming apparatus including its executor that executes at least one from the image reading function, the copy function and the print function of the image forming apparatus, and thereby making the image forming apparatus perform operations as if acting on a voluntary basis, in response to an instruction given by a user via an operation portion of the image forming apparatus.

15. The image forming apparatus control program recited in claim 14, further comprising:
searching among a plurality of virtual image forming apparatuses with different specifications for respective users, a virtual image forming apparatus related to a user giving an instruction when it is given via the operation portion of the image forming apparatus, then activating the virtual image forming apparatus, and
wherein:
the activated virtual image forming apparatus controls the image forming apparatus in the controlling step.

16. The image forming apparatus control program recited in claim 14, further comprising:
searching among a plurality of virtual image forming apparatuses with different specifications, a virtual image forming apparatus related to any of a plurality of image forming apparatuses when an instruction is given via the operation portion of this image forming apparatus, then activating the virtual image forming apparatus, and
wherein:
the activated virtual image forming apparatus controls the image forming apparatus in the controlling step.

17. The image forming apparatus control program recited in claim 14, further comprising:
setting up a virtual image forming apparatus to control a plurality of image forming apparatuses and make them work together; and
making the respective image forming apparatuses execute different functions, by using the setup virtual image forming apparatus.
